(19) United States
(12) Patent Application Publication
(10) Pub. No.: US 2021/0180484 A1
(43) Pub. Date: Jun. 17, 2021

(54) HYBRID OIL PAN FOR VEHICLE

(71) Applicants: HYUNDAI MOTOR COMPANY, Seoul (KR); KIA MOTORS CORPORATION, Seoul (KR)

(72) Inventors: Won Hyuk Koh, Seoul (KR); Joong Hyun Hwang, Suwon-si (KR); Kam Chun Lee, Geoje-si (KR); Seok Jun Yoon, Anyang-si (KR)

(21) Appl. No.: 17/008,976

(22) Filed: Sep. 1, 2020

(30) Foreign Application Priority Data
Dec. 11, 2019 (KR) 10-2019-0164337

(51) Int. Cl. F01M 11/00

(52) U.S. Cl. CPC F01M 11/0004; F01M 2011/002; F01M 2011/0091; F01M 2011/0058

(57) ABSTRACT

A hybrid oil pan for a vehicle includes a body part which is molded with a plastic material to reduce the weight, and a portion of the oil pan that is fastened to a transmission has increased dynamic rigidity to cope with the deformation caused by the dynamic behavior of the transmission.

### CROSS REFERENCE TO RELATED APPLICATION

The present application claims priority to Korean Patent Application No. 10-2019-0164337, filed on Dec. 11, 2019, the entire contents of which is incorporated herein for all purposes by this reference.

### BACKGROUND

The present invention relates to a hybrid oil pan for a vehicle and, more particularly, to a hybrid oil pan used in a vehicle for reducing weight and increasing dynamic rigidity.

### Description of the Related Art

Typically, vehicles are equipped with oil pans to store engine oil. The oil pan is mounted to the lower side of an engine and fastened to the transmission side, and is divided into an integral type and a removable type.

Since heavy loads, such as transmissions, are fastened, the integral type oil pan cannot be applied with a plastic material with weak rigidity, and the integral type oil pan is formed of aluminum. The removable type oil pan consists of an upper pan part formed of an aluminum material and a lower pan part formed of a plastic material, combined with the upper pan part.

The oil pan to which a load such as a transmission is mounted may be deformed due to the dynamic behavior of the transmission, and thus, a plastic material having a weak rigidity cannot be used at a part engaged with the transmission.

Most oil pans are thus formed from a single piece using an aluminum material. However, such an integral type oil pan made of aluminum, due to the characteristics of the aluminum material, causes an increase in weight and in heat loss of engine oil, and deteriorates fuel efficiency due to the increase in heat loss of the engine oil.

In the case of the removable type oil pan, although only the upper pan part that is fastened to the transmission is made of aluminum, since the upper pan part and the lower pan part need to be assembled after being separately fabricated, the oil pan has problems including a reduction in design freedom and an increase in material and manufacturing costs.

### SUMMARY

Accordingly, the present disclosure has been made keeping in mind the above problems occurring in the related art, and an objective of the present disclosure is to provide a hybrid oil pan for a vehicle, in which a body part of the oil pan is molded with a plastic material to reduce the weight, and a portion of the oil pan that is fastened to a transmission has increased dynamic rigidity to cope with the deformation caused by the dynamic behavior of the transmission.

In order to achieve the above objective, according to one aspect of the present disclosure, there is provided a hybrid oil pan for a vehicle, the hybrid oil pan including: a first body section having a transmission mounting part fastened to a transmission, the first body section being formed of a metal material; and a second body section having an oil storage space and integrally formed with the first body section, the second body section being formed of a plastic material.

The first body section may include a body overlapping part integrally formed with the transmission mounting part, and wherein the second body section includes a first oil storage part integrally formed with an inner surface of the body overlapping part to surround a first space side of the oil storage space, and a second oil storage part integrally formed with the first oil storage part to surround a second space side of the oil storage space.

The first space side may correspond to one side space of the oil storage space and the second spaced side may correspond to the other side space of the oil storage space.

The body overlapping part may have one or more coupling holes, and when the second body section is molded, a plastic resin of the plastic material for forming the second body section may be provided in the coupling holes to fill the coupling holes.

The coupling hole may be disposed on an edge portion of the body overlapping part adjacent to the second oil storage part.

A bottom portion of the body overlapping part may be provided with a first center floor having a predetermined height difference from a bottom portion of the second oil storage part, the first center floor having an arcuate cross-section bent toward the first space side.

The first center floor may be disposed at the center of the bottom portion of the body overlapping part.

The bottom portion of the body overlapping part may be provided with a second center floor disposed between the first center floor and the second oil storage part, the second center floor having an arcuate cross-section bent toward the first space side.

The first center floor may be provided with a plurality of holes, and when the second body section is molded, a plastic resin of the plastic material for forming the second body section may be provided in the holes to fill the holes.

The first center floor may comprise a grid-type reinforcement rib on an outer surface of the first center floor.

A partition rib may be provided on an outer surface of the body overlapping part, and during the molding of the first oil storage part, the plastic resin for forming the second body section may pass through the coupling holes on an inner side of the body overlapping part and fill up to an end of the partition rib.

According to the present disclosure, the first body section which is engaged with the transmission is molded with an aluminum material, and the second body section integrally formed with the first body section is molded with a plastic material, thereby increasing the dynamic rigidity of the oil pan while reducing the weight, and thus having effects of reducing the vibration and noise in the mid-high frequency range and improving the fuel efficiency.

In particular, since the oil pan has various structures capable of increasing the coupling force and rigidity of the first body section and the second body section during injection molding of the second body section, the oil pan may secure dynamic rigidity at the same level as a conventional aluminum oil pan.

### BRIEF DESCRIPTION OF THE DRAWINGS

The above and other objectives, features and advantages of the present disclosure will be more clearly understood from the following detailed description when taken in conjunction with the accompanying drawings, in which:

FIG. 1 is a perspective view illustrating a hybrid oil pan for a vehicle according to an embodiment of the present disclosure;

FIG. 2 is a perspective view illustrating a hybrid oil pan for a vehicle according to a disclosure of the present disclosure;

FIG. 3 is a perspective view illustrating a first body section according to an embodiment of the present disclosure;

FIG. 4 is a cross-sectional view taken along line A-A of FIG. 1;

FIG. 5 is a partial cross-sectional view in one direction illustrating the oil pan of the present disclosure;

FIG. 6 is a partial cross-sectional view in another direction illustrating the oil pan of the present disclosure; and

FIG. 7 is a cross-sectional view illustrating the first body section of the present disclosure.

### DETAILED DESCRIPTION

Hereinbelow, exemplary embodiments of the present disclosure will be described in detail with reference to the accompanying drawings to allow those skilled in the art to easily implement the embodiments. However, the present disclosure is not limited to those embodiments, but may be implemented into other forms.

A hybrid oil pan for a vehicle according to the present disclosure has a structure in which a body section of the oil pan is molded with a plastic material to reduce the weight, and a portion of the oil pan engaged with a transmission has increased dynamic rigidity to cope with the deformation caused by the dynamic behavior of the transmission.

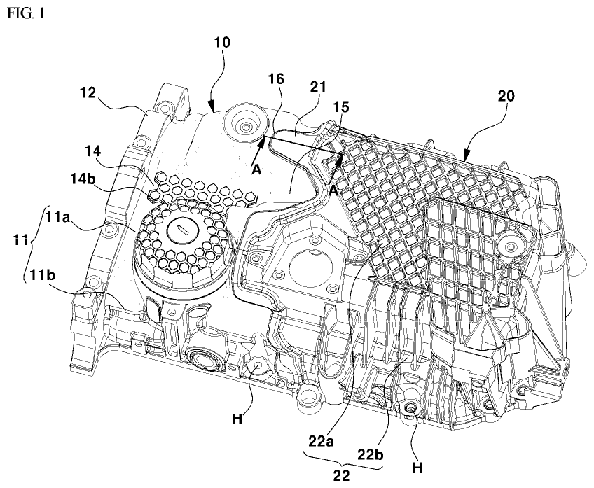

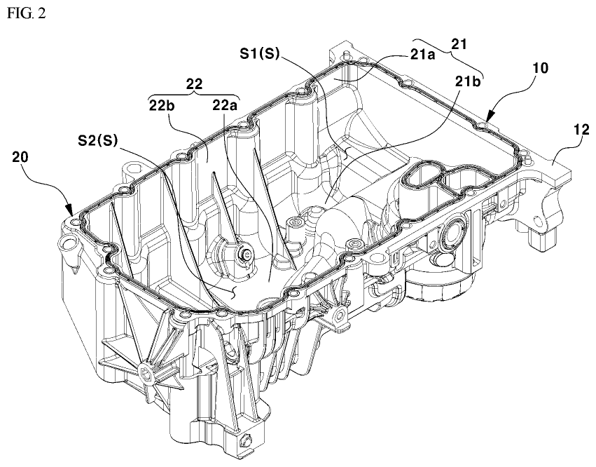

As illustrated in FIGS. 1 and 2, the oil pan includes a first body section 10 having a transmission mounting part 12 and a second body section 20 integrally formed with the first body section 10, wherein the second body section is formed of a plastic material.

The first body section 10 may be formed of a metal material such as aluminum, and may be fastened to one side of a transmission through the transmission mounting part 12.

The second body section 20 is formed of a plastic material that is lighter than aluminum, and has an oil storage space S in which engine oil is accommodated. The oil storage space S consists of a first space part S1 corresponding to one side of the oil storage space S and a second space part S2 corresponding to the other side of the oil storage space S. That is, the oil storage space S is composed of a first space part S1 constituting one side of the oil storage space S and a second space part S2 constituting the other side of the oil storage space S.

The first body section 10 includes a transmission mounting part 12 coupled to a transmission and a body overlapping part 11 integrally formed with the transmission mounting part 12.

The transmission mounting part 12 may be disposed adjacent to one end (i.e., the first end) of the body overlapping part 11. In other words, the transmission mounting part 12 may be formed to extend from the first end of the body overlapping part 11.

The body overlapping part 11 may be a metal structure surrounding the first space S1 together with the second body section 20. The body overlapping part 11 may be composed of a bottom 11a disposed on a bottom surface of the first space part S1 and sidewalls 11b integrally formed on both ends of the bottom portion 11a and disposed on the lateral sides of the first space part S1.

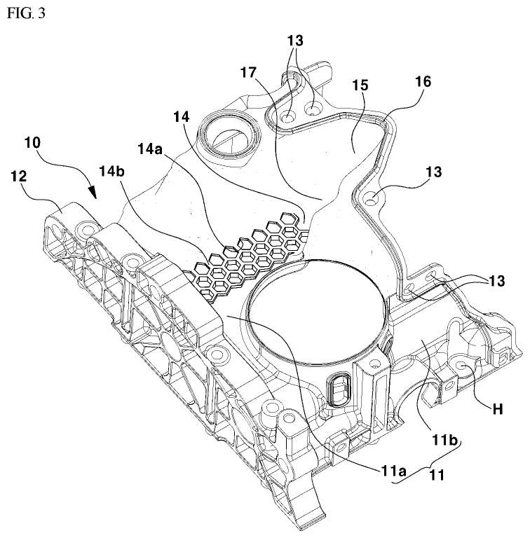

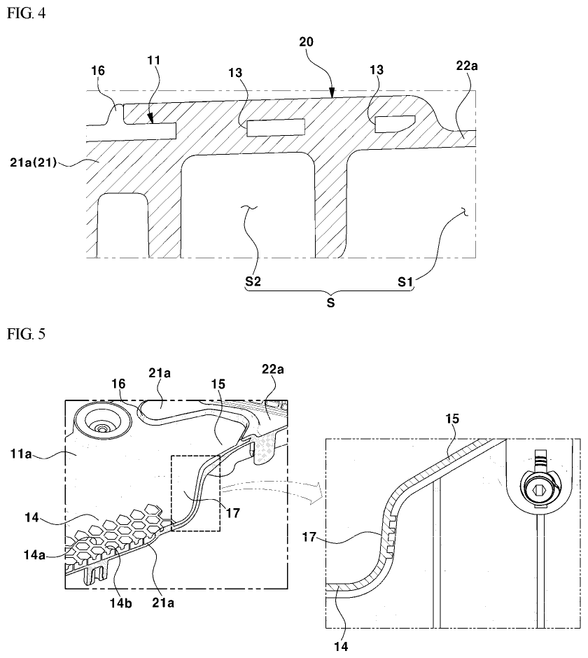

As illustrated in FIGS. 3 and 4, the body overlapping part 11 may be provided with one or more coupling holes 13 to increase the coupling force between the first body section 10 and the second body section 20 integrally molded to the first body section 10. The coupling hole 13 is filled with a plastic resin of the plastic material used for molding the second body section 20 during injection molding of the second body section 20.

The second body section 20 may be formed by insert injection molding using a mold. That is, the second body section 20 is fabricated by injecting a plastic resin into a mold for the second body section 20 in a state in which the first body section 10 is inserted into the mold. Specifically, by injecting the plastic resin for molding the second body section 20 into the cavity in the mold in the state in which the first body section 10 is inserted and disposed at a predetermined position inside the mold, the second body section 20 is integrally molded with the first body section 10. At this time, the plastic resin for forming the second body section 20 is provided in the coupling holes 13 to fill the coupling holes 13 (see FIG. 4). That is, when the second body section 20 is molded, the plastic resin fills the coupling holes 13. As the plastic resin is cured in a state of filling the coupling holes 13, the first body section 10 and the second body section 20 can secure a coupling force using riveting.

As illustrated in FIG. 3, the coupling hole 13 may be disposed at an edge portion (i.e., an opposite edge portion of the transmission mounting part) of the body overlapping part 11 adjacent to a second oil storage part 22 of the second body section 20. In addition, the coupling hole 13 may also be disposed at other positions of the body overlapping part 11.

As illustrated in FIGS. 1 and 2, the second body section 20 may include a first oil storage part 21 integrally formed with an inner surface of the body overlapping part 11, and a second oil storage part 22 integrally formed with the first oil storage part 21. The first oil storage part 21 may be molded to surround the first space S1 of the oil storage space S, and the second oil storage part 22 may be molded to surround the second space S2 of the oil storage space S. The first oil storage part 21 may have a bottom portion 21a disposed on the bottom surface of the first space S1 and sidewall portions 21b integrally formed with ends (i.e., edges) of the bottom portion 21a and disposed on lateral sides of the first space S1. The second oil storage part 22 may have a bottom portion 22a disposed on the bottom surface of the second space S2 and sidewall portions 22b integrally formed with ends of the bottom portion 22a and disposed on lateral sides of the second space S2.

In addition, as illustrated in FIGS. 3 and 5, the bottom portion 11a of the body overlapping part 11 may be provided with a first center floor 14 having a height difference greater than a predetermined value from the bottom portion 22a of the second oil storage part 22. In order to increase the coupling force between the first body section 10 and the second body section 20, the first center floor 14 may preferably have an arcuate cross-sectional structure that is convexly curved toward the first space S1. That is, the first center floor 14 may have a curved structure that is bent toward the first space S1. The height difference may be a height difference on the basis of the height direction of the oil storage space S.

The load of the transmission fastened to the transmission mounting part 12 directly affects the center of the bottom portion 11a of the body overlapping part 11. Therefore, the first center floor 14 is preferably disposed at the center of the bottom portion 11a of the body overlapping part 11. The center of the bottom portion 11a is provided between both sidewall portions 11b of the body overlapping part 11.

The first center floor 14 is disposed at the center of the body overlapping part 11, thereby increasing structural rigidity of the body overlapping part 11, as well as increasing the coupling force between the first body section 10 and the second body section 20.

In addition, a second center floor 15 may be further provided at the bottom portion of the body overlapping part 11. As illustrated in FIG. 1, the second center floor 15 is disposed between the first center floor 14 and the second oil storage part 22. In order to increase the coupling force between the first body section 10 and the second body section 20, the second center floor 15 may preferably have an arcuate cross-sectional structure that is convexly curved toward the first space S1. That is, the second center floor 15 may have a curved surface that is bent toward the second space S2.

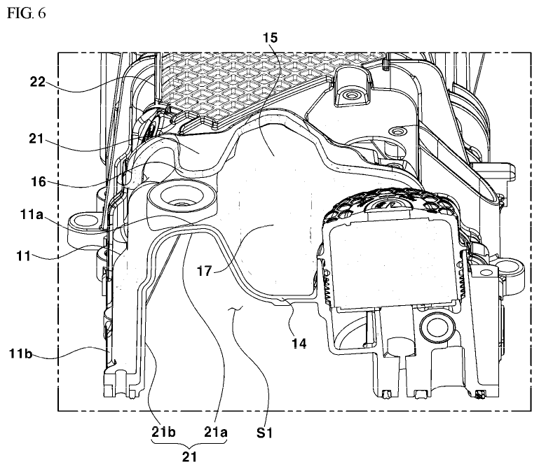

A height difference exists between the second center floor 15 and the first center floor 14, and thus an undercut portion 17 may be provided between the second center floor 15 and the first center floor 14. As illustrated in FIGS. 5 and 6, the undercut portion 17 may be disposed vertically in the height direction of the oil storage space S.

Although the bottom portion 11a of the body overlapping part 11 may be configured as a flat plate, the bottom portion is preferably provided with the first center floor 14 and the second center floor 15 to prevent buckling caused by the load of the transmission.

In addition, the first center floor 14 may be provided with a plurality of holes 14a. The holes 14a may be arranged in multiple columns and rows on the first center floor 14. When the second body section 20 is molded, a plastic resin for molding the second body section 20 may be provided in the holes 14a to fill the holes 14a. As the holes 14a are filled with the plastic resin, the coupling force between the first body section 10 and the second body section 20 may be further increased.

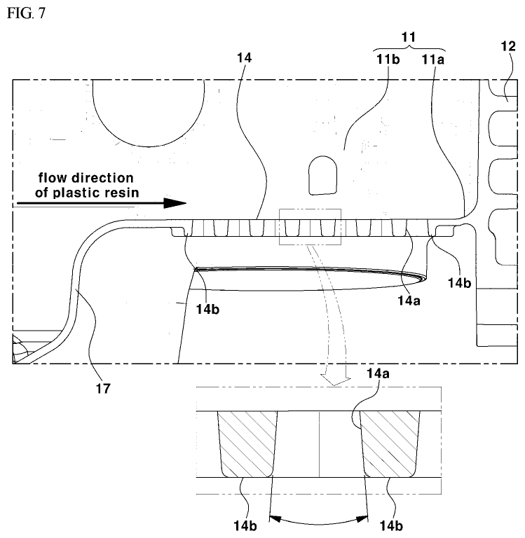

When the first oil storage part 21 is molded during the molding of the second body section 20, the plastic resin flows over the inner surface of the bottom portion 11a of the body overlapping part 11 (see FIG. 7). Therefore, since the holes 14a are formed in the first center floor 14, when the first oil storage part 21 of the second body section 20 is molded, the area of the inner surface of the body overlapping part 11 that is in contact with the plastic resin may be reduced.

When the plastic resin comes into contact with the first body section 10 during the injection molding of the second body section 20, the flowing characteristic (fluidity) of the plastic resin is deteriorated due to a much greater difference in temperature and thus the molding quality of the second body section 20 may be degraded. Accordingly, the injection molding quality of the second body section 20 may be increased by minimizing the area of the first body section 10 that is in contact with the plastic resin.

In addition, the outer surface of the first center floor 14 may be provided with a grid-type reinforcement rib 14b. The grid-type reinforcing rib 14b may protrude from the outer surface of the first center floor 14 and may be disposed at the lower outer side of the hole 14a (see FIG. 7).

Due to the nature of the oil pan mounted on the lower part of an engine, the oil pan may be damaged by splashing of stones or the like on the road surface. The grid-type reinforcement rib 14b may increase rigidity of the oil pan against external impact. Therefore, since the first center floor 14 is provided with a grid-type reinforcement rib 14b together with the hole 14a, the injection molding quality and the rigidity of the oil pan may be increased.

Further, in order to increase the coupling force between the body overlapping part 11 and the first oil storage part 21, the hole 14a of the first center floor 14 is preferably formed in a shape tapered from the inner side toward the outer side of the bottom portion 11a of the body overlapping part 11. That is, the diameter of the hole 14a is preferably increased gradually from the inner side toward the outer side of the bottom portion 11a. The hole 14a may have various shapes such as honeycomb, rectangle, or the like.

In addition, a partition rib 16 may be provided on an outer surface of the bottom portion 11a of the body overlapping part 11. The partition rib 16 may be disposed on the outer surface of the bottom portion 11a of the body overlapping part 11 according to a set pattern, and may be formed to protrude from the outer surface of the bottom portion 11a. The plastic resin for forming the second body section 20 passes through the coupling hole 13 on the inner side of the body overlapping part 11 and reaches and fills an end point (that is, an end height) of the partition rib 16 during molding of the first oil storage part 21 (see FIG. 4).

Although not shown in the drawings, when injected into a mold for forming the second body section 20, the plastic resin first fills the cavity for forming the second oil storage part 22 and then fills the cavity for forming the first oil storage part 21. The plastic resin flows along the outer surface and the inner surface of the body overlapping part 11 for forming the first oil storage part 21. At this time, the plastic resin flowing along the outer surface of the body overlapping part 11 flows only up to the partition rib 16. The partition rib 16 may restrict and stop the flow of the plastic resin flowing along the outer surface of the body overlapping part 11.

In addition, in FIG. 1, reference numeral H denotes a bolt hole H of the oil pan. The oil pan may be coupled to the lower part of an engine by a bolt member bolted through the bolt hole H.

Although the embodiments of the present disclosure have been described in detail, the scope of the present disclosure is not limited to the above-described embodiments, and various modifications and changes performed by those skilled in the art using the basic concepts of the present disclosure defined in the following claims are also included in the scope of the present disclosure.

What is claimed is:

1. A hybrid oil pan for a vehicle, the hybrid oil pan comprising:
a first body section having a transmission mounting part fastened to a transmission, wherein the first body section comprises a metal material; and
a second body section having an oil storage space and integrally formed with the first body section, wherein the second body section comprises a plastic material.

2. The hybrid oil pan for a vehicle according to claim 1, wherein the first body section includes a body overlapping part integrally formed with the transmission mounting part, and the second body section includes a first oil storage part integrally formed with an inner surface of the body overlapping part to surround a first space side of the oil storage space, and a second oil storage part integrally formed with the first oil storage part to surround a second space side of the oil storage space.

3. The hybrid oil pan for a vehicle according to claim 2, wherein the first space side corresponds to one side space of the oil storage space and the second spaced side corresponds to the other side space of the oil storage space.

4. The hybrid oil pan for a vehicle according to claim 2, wherein the body overlapping part has one or more coupling holes, and when the second body section is molded, the plastic material for forming the second body section fills in the coupling holes.

5. The hybrid oil pan for a vehicle according to claim 4, wherein the coupling hole is disposed on an edge portion of the body overlapping part adjacent to the second oil storage part.

6. The hybrid oil pan for a vehicle according to claim 2, wherein a bottom portion of the body overlapping part comprises a first center floor having a predetermined height difference from a bottom portion of the second oil storage part, the first center floor having an arcuate cross-section bent toward the first space side.

7. The hybrid oil pan for a vehicle according to claim 6, wherein the first center floor is disposed at the center of the bottom portion of the body overlapping part.

8. The hybrid oil pan for a vehicle according to claim 6, wherein the bottom portion of the body overlapping part comprises a second center floor disposed between the first center floor and the second oil storage part, the second center floor having an arcuate cross-section bent toward the first space side.

9. The hybrid oil pan for a vehicle according to claim 6, wherein the first center floor comprises a plurality of holes, and when the second body section is molded, a plastic resin of the plastic material for forming the second body section fills in the holes.

10. The hybrid oil pan for a vehicle according to claim 6, wherein the first center floor comprises a grid-type reinforcement rib on an outer surface of the first center floor.

11. The hybrid oil pan for a vehicle according to claim 4, wherein a partition rib is disposed on an outer surface of the body overlapping part, and during the molding of the first oil storage part, the plastic resin for forming the second body section passes through the coupling holes on an inner side of the body overlapping part and fills up to an end of the partition rib.
